(19) United States
(12) Patent Application Publication
(10) Pub. No.: US 2026/0165303 A1
(43) Pub. Date: Jun. 18, 2026

(54) PREDICTIVE MODELING FOR MOBILITY OF DOG MOVEMENT

(71) Applicant: Société des Produits Nestlé S.A., Vevey (CH)

(72) Inventors: Ragen Trudelle-Schwarz McGowan, Saint Joseph, MO (US); Natalie Langenfeld-McCoy, Bethalto, IL (US); Helber Dussan, Saint Louis, MO (US); Olivia Arndt, Saint Joseph, MO (US); Nicholas Schoeneck, Saint Joseph, MO (US); Shivam Awasthi, Barabanki (IN); Mohammed Affan Khan, PERAMBUR (IN); Dwarakanath Raghavendra Ravi, Adyar (IN); Abhishek Sai Nasanuru, Tirupati (IN); Satyam Purwar, Uttar Pradesh (IN); Devanand Rajeev, Kollam (IN); Moneesh Basker, Hosur (IN)

(73) Assignee: Société des Produits Nestlé S.A., Vevey (CH)

(21) Appl. No.: 19/378,647

(22) Filed: Nov. 4, 2025

Related U.S. Application Data
(60) Provisional application No. 63/735,110, filed on Dec. 17, 2024.

(51) Int. Cl. A01K 29/00; A01K 27/00

(52) U.S. Cl. CPC A01K 29/007; A01K 27/001; A01K 27/009

(57) ABSTRACT

Methods of predicting mobility of dog movement, under the control of at least one processor, can include collecting movement sensor data from a wearable monitoring device positioned on a dog, wherein the wearable monitoring device includes an accelerometer and a gyroscope (each capable of collecting three axial signals), a processor, and a memory storing instructions that, when executed by the processor, accumulates the movement sensor data in time windows. The method further includes classifying movement behavior as a binary of walk or trot within at least a plurality of the time windows based on the movement sensor data collected from multiple axes of the accelerometer and multiple axes of the gyroscope, and predicting mobility of dog movement based on the movement behaviors as applied to a trained artificial intelligence mobility model. Predicting the mobility of the dog movement can include predicting a binary of healthy mobility or compromised mobility.

### CROSS REFERENCE TO RELATED APPLICATION

This application claims priority to U.S. Provisional Application Ser. No. 63/735,110 filed Dec. 17, 2024 the disclosure of which is incorporated in its entirety herein by this reference.

### BACKGROUND

Pet health is of particular interest to pet owners, and as such, many pet owners are looking for ways of prediction the health of their pets using technology. For example, pet sensors, cameras, monitoring equipment, etc., is available in the marketplace to provide pet owners a technology solution for improving the care they give to their pets. For example, smart collars have emerged in recent years that can provide information to pet owners regarding pet location, tracking, etc., which can be presented as pet data charts, graphs, trends, or the like. However, these smart collars typically do not provide meaningful health insights, such as providing information as to what the collected data means or providing information related to enhancing or optimizing the pet's health and/or wellbeing.

### BRIEF DESCRIPTION OF THE FIGURES

FIG. 1 schematically illustrates an example prediction system for mobility of dog movement in accordance with the present disclosure;

FIG. 2 is an exploded view of an example wearable monitoring device in accordance with the present disclosure;

FIG. 3A schematically illustrates an example triaxial accelerometer usable in the wearable monitoring devices in accordance with the present disclosure;

FIG. 3B schematically illustrates an example triaxial gyroscope usable in the wearable monitoring devices in accordance with the present disclosure;

FIG. 4 is a flow diagram illustrating example independent collection of triaxial signal from an accelerometer and a gyroscope and the calculating of magnitude data in accordance with the present disclosure;

FIG. 5 is a graph illustrating example collection of movement sensor data over time in accordance with the present disclosure; and

FIG. 6 is a flow diagram illustrating an example method of predicting mobility of dog movement in accordance with the present disclosure.

### DETAILED DESCRIPTION

The present disclosure relates to animal health and wellbeing, and more particularly to predictive modeling for mobility of dog movement using artificial intelligence and movement sensor data collected on a wearable monitoring device. For example, the present disclosure relates to methods of predicting the mobility of dog movement, prediction systems for mobility of dog movement, and non-transitory machine readable storage media for implementing the methods and/or using the systems described herein.

In accordance with the present disclosure, a method of predicting the mobility of dog movement, under the control of at least one processor, can include collecting movement sensor data from a wearable monitoring device positioned on a dog, wherein the wearable monitoring device includes an accelerometer capable of collecting three accelerometer axial signals, a gyroscope capable of collecting three gyroscope axial signals, a processor, and a memory storing instructions that, when executed by the processor, accumulates the movement sensor data in time windows. The method can further include classifying movement behavior as a binary of walk or trot within at least a plurality of the time windows based on the movement sensor data collected from multiple axes of the accelerometer and multiple axes of the gyroscope, and predicting mobility of dog movement based on the movement behaviors as applied to a trained artificial intelligence mobility model. Predicting the mobility of the dog movement can include predicting a binary of healthy mobility or compromised mobility.

In another example, a prediction system for mobility of dog movement can include a wearable monitoring device positionable on a dog, wherein the wearable monitoring device includes an accelerometer, a gyroscope, a processor, a memory storing instructions that, when executed by the processor, accumulates movement sensor data using three accelerometer axes and three gyroscope axes. The system can further include a machine classifier to classify movement behaviors as a binary of walk or trot within at least a plurality of the time windows based on the movement sensor data, and a trained artificial intelligence model to provide a mobility prediction for dog movement based on the movement behaviors. The mobility prediction can also be selected from a binary of healthy mobility or compromised mobility.

In another example, a non-transitory machine readable storage medium can have instructions embodied thereon, wherein the instructions when executed cause a processor to perform a method of predicting mobility of dog movement. The storage medium can provide instructions, for example, including accumulating movement sensor data in time windows using three axes of an accelerometer and three axes of a gyroscope, and classifying movement behavior as walk or trot within at least a plurality of the time windows based on the movement sensor data. Regarding predicting the mobility of the dog movement, the instructions can provide one or both of predicting mobility of the dog movement based on the movement behaviors as applied to a trained artificial intelligence mobility model, e.g., the mobility of dog movement predicted can be a mobility prediction of dog movement selected from healthy mobility or compromised mobility, or transmitting data collected from classifying the movement behaviors over a network or non-network link to an analysis server, a cloud computing system, a client device, or a combination thereof where predicting the mobility of the dog movement may occur.

In accordance with these embodiments and others described herein, the term “binary” may be used in at least two contexts, namely to include the distinguishing between two movement behaviors (walk or trot) and the distinguishing between two mobility predictions of dog movement (healthy mobility and compromised mobility) that may be based on the movement behaviors sensed by the wearable mobility device. That is not to say that there are other movement behaviors and/or mobility predictions of dog movement that cannot be gathered from the wearable mobility device and artificial intelligence. Thus, the term “binary” is not intended to be limiting, except in the extent that it is capable of distinguishing between these two movement behaviors and resultant two mobility predictions of dog movement. For example, even though the wearable mobility device and artificial intelligence described herein are used to predict one of two types of mobility conditions of dog movement, the wearable mobility device can also be used for sensing other health parameters and/or can also be used to more specifically identify more specific compromised mobility conditions, e.g., arthritis, spondylosis, hip dysplasia, etc. The detection of more specific compromised mobility conditions (beyond just that the mobility is compromised) may benefit from utilizing similar features or even some other features that would provide enough information to distinguish one specific compromised condition over another specific compromised condition. Thus, the term “binary” should not be considered to be limiting, as it merely indicates that the systems and methods described herein are at least inclusive of making binary decisions as to two categories of movement behaviors and two categories of mobility predictions of dog movement.

Additional features and advantages of the disclosed methods, systems, and storage media are described in and will be apparent from the following specification and figures. The features and advantages described herein are not all-inclusive and, in particular, many additional features and advantages will be apparent to one of ordinary skill in the art in view of the present specification and figures. Moreover, it should be noted that the language used in the specification has been principally selected for readability and instructional purposes, and not to limit the scope of the inventive subject matter.

### Prediction Systems for Mobility of Dog Movement

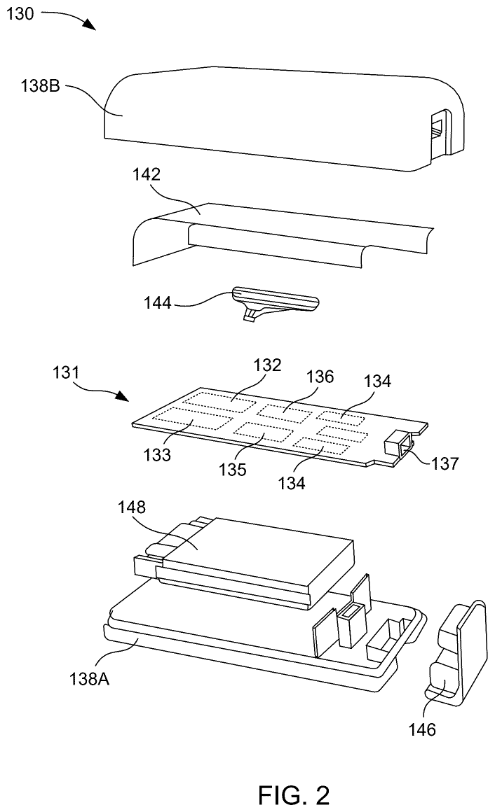

In accordance with the present disclosure, an example prediction system 100 for mobility of dog movement is illustrated. As a note, this is merely one example of how a prediction system for mobility of dog movement can be arranged and it is understood that there are many other arrangements that can be utilized with the systems and methods of the present disclosure. However, in this example, the prediction system for mobility of dog movement is shown to include a client device 110, an analysis server system 120 (which can be a single server, part of a larger network of servers, cloud computing system, etc.), a wearable monitoring device 130 that can be carried by a dog using a dog collar 140, and a network 150 connecting the client device(s) and/or wearable monitoring device(s) to the analysis server system. Additional details regarding an example wearable monitoring device are illustrated by way of example in FIG. 2.

Client devices 110 can include, for example, desktop computers, laptop computers, smartphones, tablets, and/or any other user interface suitable for communicating with the wearable monitoring devices 130. Client devices can obtain a variety of data from one or more wearable monitoring devices, provide data and insights regarding the subject dog via one or more software applications, and/or provide data and/or insights to the analysis server system 120 as described herein. The software applications can utilize trained artificial intelligence to provide movement sensor data regarding the mobility of the dog movement for a dog wearing the wearable monitoring device and/or provide predictive health or wellness information regarding the dog. In some embodiments, the software applications obtain data from the analysis server systems for processing and/or display.

The analysis server systems 120 as described herein can obtain data from one or more of the client devices 110 and/or wearable monitoring device 130 as described herein, and the analysis server systems can provide data and insights regarding a subject dog and/or transmit data and/or insights to the client devices and/or the analysis server systems. These insights can include, but are not limited to, insights regarding mobility of dog movement, and more specifically, whether the mobility of dog movement reflects healthy mobility or compromised mobility. In some examples, the analysis server systems obtain data from multiple client devices and/or wearable monitoring devices and identify insights that can be used to provide recommendations for a particular dog that may be identified as exhibiting compromised mobility. In some examples, the analysis server systems can provide a computer application, a web-based portal (e.g., a web site), or the like for providing access to pet owners and/or vets for further diagnoses.

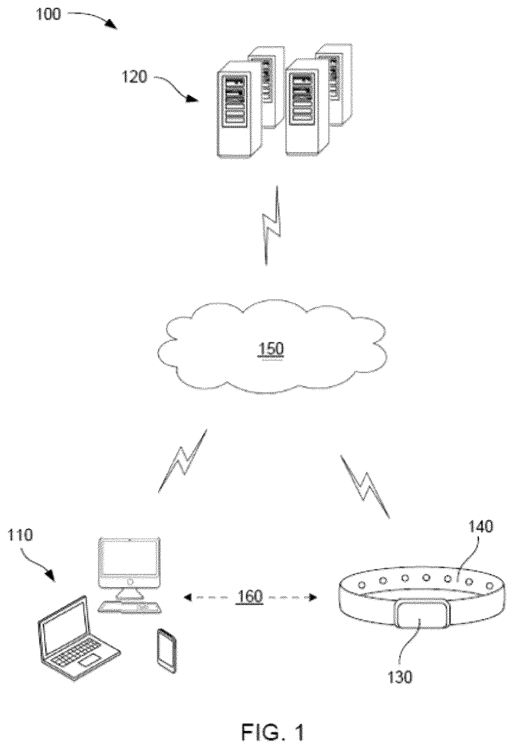

The wearable monitoring device 130 can include hardware and software/firmware suitable for accumulating movement sensor data. For example, the wearable monitoring device can include a triaxial accelerometer and a triaxial gyroscope for accumulating movement sensor data that can be interpreted as the behavior of walk or trot. In some examples, time windows can be programmed for collecting the movement sensor data, and some of the time windows can be identified sequentially as block of time windows indicating the behavior of walk or trot. In addition, the wearable monitoring device can include a processor and a memory storing instructions that, when executed by the processor, accumulates the movement sensor data using three accelerometer axes and three gyroscope axes. In accordance with this, the sensors controlled by the software/firmware can provide movement sensor data that distinguishes between healthy mobility of the dog movement and compromised mobility of the dog movement, e.g., arthritis, spondylosis, hip dysplasia, etc.). In further detail, due to the use of the triaxial sensors, e.g., the accelerometer and the gyroscope, movement sensor data can be used to characterize overall movement of the dog via a magnitude signal as well as asymmetric movement of the dog as a result of the triaxial nature of the sensors, e.g., individual axial signals provide asymmetric movement data. With this type of movement sensor data collected, individual dogs wearing the wearable monitoring devices can be monitored for one of two movement behaviors or activities, namely walk or trot. Notably, other types of behaviors, such as sleeping, running, lying still, etc., can be excluded, as in some examples, the movement behavior of walk or trot are typically enough to determine, using trained artificial intelligence, whether a dog exhibits healthy mobility traits or compromised mobility traits. It is noted, however, that classifying the movement behavior of walk or trot (based on the movement sensor data) and/or predicting mobility of dog movement based on the movement behaviors as applied to a trained artificial intelligence mobility model can occur onboard the wearable monitoring device or can take place over a network 150 via the analysis server systems 120 and/or at the client device 110 where processing and/or analysis may be done. In further detail, the wearable monitoring device can be adapted to be attached to a wearable article 140, such as a collar as shown in FIG. 1, but could be attached to other wearable articles, e.g., clips, ribbons, body leashes, vests, etc. Additional detail related to the wearable monitoring device is described further in connection with FIG. 2 hereinafter.

In some examples, the prediction system 100 for mobility of dog movement and/or methods can utilize a network 150 for communicating between any combination of wearable monitoring device 130, the client device(s) 110, and/or the analysis server system(s) 120. All three components can thus communicate via the network, or any two components can communicate via the network. However, in some examples, the wearable monitoring devices can communicate directly with a client device without sending movement sensor data through the network. In other words, the client device may be a non-network client device (as illustrated by a local non-network link 160, which can be wired or wireless). The term “non-network” client device does not infer it is not also connected via the cloud or other network, but merely that there is a wireless or wired connection that can be present directly with the wearable monitoring device. For example, the wearable monitoring devices and the non-network client device can communicate via Bluetooth or other local connection. If analysis is carried out on the analysis server system(s), then either or both of the wearable monitoring device and/or the client device(s) can communicate with the analysis server system(s) via the network. As stated, the wearable monitoring device can alternatively process the movement sensor data directly onboard, excluding the need for processing to occur on the analysis server system(s). In some examples, some division of processing (or even redundancy of processing) may be acceptable as well, such as may be the case where some or all of the processing/analysis is carried out onboard the wearable monitoring device and some or all of the analysis that is alternatively or additionally carried out on the analysis server system(s). In further detail, the wearable monitoring device can utilize the sensors that are onboard the wearable monitoring device for purposes of calibration, setup, troubleshooting, etc., as may be beneficial for providing accurate movement sensor data when in use. In this instance, automatic or manual adjustment of one or more of the sensors, e.g., the accelerometer and/or the gyroscope, can be carried out using the client device(s) in non-network communication with the wearable monitoring device directly (shown as 160) or over the network (as shown at 150). In other examples, a device controller (not shown) may be present directly on the wearable monitoring device, e.g., button(s), touch screen, indicator lights, etc., for assisting with or carrying out setup, calibration, troubleshooting, etc., functions.

The prediction system 100 for mobility of dog movement as shown, which can include the client device(s) 110, the analysis server system(s) 120, and the wearable monitoring device 130 can independently include a single computing device, and more particularly in the case of the client device(s) and the analysis server system(s), these components can include multiple computing devices, a cluster of computing devices, or the like. Regardless of the setup of each of these components, the computing device(s) can include one or more physical processors communicatively coupled to memory devices, input/output devices, or the like. As used herein, the term “processor” may be referred to as a central processing unit (CPU) or other similar terminology.

In accordance with this, any of the processors in use in a prediction system for mobility of dog movement and/or method of predicting the mobility of dog movement can include one or more devices capable of executing instructions encoding arithmetic, logical, and/or I/O operations. In one illustrative example, a processor may implement a Von Neumann architectural model and may include an arithmetic logic unit (ALU), a control unit, and a plurality of registers. In many aspects, a processor may be a single core processor that is typically capable of executing one instruction at a time (or process a single pipeline of instructions) and/or a multi-core processor that may simultaneously execute multiple instructions. In some examples, a processor may be implemented as a single integrated circuit, two or more integrated circuits, and/or may be a component of a multi-chip module in which individual microprocessor dies are included in a single integrated circuit package and hence share a single socket. As discussed herein, the term “memory” refers to a volatile or non-volatile memory device, such as RAM, ROM, EEPROM, or any other device capable of storing data, e.g., movement sensor data, and/or carrying instructions that can be executed by the processor. Input/output devices can include a network device, e.g., a network adapter or any other component that connects a computer to a computer network, a peripheral component interconnect (PCI) device, storage devices, disk drives, etc. In some instances, there may be other useful components as well, such as connected sound or video adaptors, photo/video cameras, printer devices, keyboards, displays, etc. In several aspects, a computing device provides an interface, such as an API or web service, which provides some or all of the movement sensor data to other computing devices for further processing. Access to the interface can be open and/or secured using any of a variety of techniques, such as by using client authorization keys, as appropriate to the requirements of specific applications of the disclosure.

In further detail regarding the network 150, this can be established to include a LAN (local area network), a WAN (wide area network), a telephone network, e.g., Public Switched Telephone Network (PSTN), a Session Initiation Protocol (SIP) network, a wireless network, a point-to-point network, a star network, a token ring network, a hub network, wireless networks (including protocols such as EDGE, 3G, 4G LTE, Wi-Fi, 5G, WiMAX, or the like), the internet, or the like. A variety of authorization and authentication techniques, such as username/password, Open Authorization (OAuth), Kerberos, SecureID, digital certificates, or more, may be used to secure the communications. It will be appreciated that the network connections shown in the example prediction system 100 for mobility of dog movement is merely illustrative, and thus, any other known electronic communication setups or methodologies of establishing one or more communication links between the various components shown, in examples where each of these components are indeed used, may be implemented.

Referring now to FIG. 2, the wearable monitoring device 130 shown positioned on a dog collar (shown at 140 in FIG. 1) is shown as an exploded view by way of example. Other assemblies can alternatively be used, provided the wearable monitoring device is equipped with both an accelerometer 135 and a gyroscope 136. The accelerometer and the gyroscope can be positioned anywhere that is associated in a fixed manner to the wearable monitoring device, but in this instance, it is shown as being part of a circuit board that also includes a processor 132, a memory 133, various data communicators, e.g., BLE, WIFI, LTE, etc., and a computer port 137. With the presence of a computer port having an opening for cable connection to the circuit board, a port cover 146 can be included to protect the computer port from dust, liquid, or other contaminants that could compromise the function of the wearable monitoring device. Also shown in this example is a power source 158, which in this instance is a rechargeable battery, that is supported by a lower housing 138A (to be ultimately closed via an upper housing 138B). Also shown is an antenna 142, which may be in any form that is suitable for data communication. For example, a low band antenna may be used as an antenna flex. In this example, a light pipe 14 may be included for directing light from the circuit board to an opening of the upper housing (or lower housing), so that the user may be provided with light indicators, for example, battery life, on/off, BTE connection, wireless connection, etc.

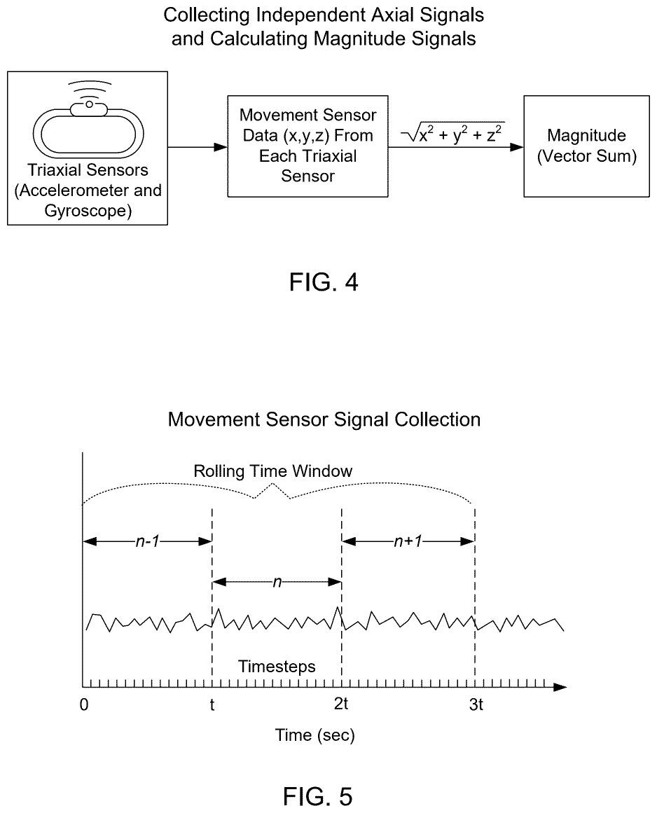

In this particular example, the accelerometer 135 and the gyroscope 136 can both be adapted with triaxial sensors, sensing movement in each of the x, y, and z axes to provide individual axial signals or axial data. Thus, the triaxial accelerometer and the triaxial gyroscope can collect movement sensor data along each of their respective three axes, which can be used to calculate overall movement via a magnitude signal as well as asymmetric movement via the triaxial nature of the sensors, e.g., individual axial signals provide asymmetric movement data. More specifically, independent asymmetric movement can be sensed along all three axes of movement, e.g., x, y, and z axes, and the magnitude of movement can be sensed by the various axes of movement and then calculated to determine the magnitude of movement. These movements by the dog wearing the wearable monitoring device, e.g., asymmetric movement and magnitude of movement, can be used for characterizing the mobility of the dog movement via the sensors, with signals being generated therefrom for processing and/or analysis onboard the wearable monitoring device, or at the client device(s) and/or analysis server systems (shown by example at 110 and 120, respectively, in FIG. 1). The calculation used to generate the magnitude signal as magnitude data is described in greater detail hereinafter at FIG. 4.

In further detail regarding the circuit board 131, the processor 132 and memory 133 can be capable of controlling the sensors, e.g., the accelerometer and the gyroscope, and the data collected using these sensors can be stored temporarily in the memory or for longer term storage. The data communicator(s) 134 can be capable of communicating the movement sensor data to another device. For example, the data communicator can be a wireless networking device with employee wireless protocols such as Bluetooth or Wi-Fi. The data communicator can send the movement sensor data to a physically remote device capable of processing the movement sensor data, such as at the client device(s) 110 and/or the analysis server systems 120 shown in FIG. 1A. The data communicator can also transmit the movement sensor data over a wired connection and can employ a data port such as a universal serial bus port. Alternatively, a memory slot can be capable of housing a removable memory card where the removable memory card can have the movement sensor data stored on it and then physically removed and transferred to another device for upload or analysis. In one embodiment, the processor 180 and memory 185 are capable of analyzing the movement sensor data without sending the movement sensor data to a physically remote device such as the analysis server system.

As mentioned, the wearable monitoring device 130 can include a power source 148. The power source can be a battery such as a replaceable battery or a rechargeable battery. The power source can be a wired power source that plugs into an electrical wall outlet, though this is less practical than the use of a battery due to the purpose of the wearable monitoring device being used for sensing mobility of dog movement of walk or trot. In other examples, the power source can be a combination of a battery and a wired power source. The wearable monitoring device may be built without other sensors in some examples, relying only on the accelerometer and the gyroscope, which may provide significant power and memory savings. However, in some examples, other sensors or electronics equipment may be used, such as an RFID tag, a camera or image capturing device, or the like. When there is a goal of keeping the weight low to the wearable monitoring device as well as the memory/processing power sufficient for use within a relatively small housing 138A and 138B, the use of fewer sensors and a smaller memory size may be desirable, particularly if the accelerometer and the gyroscope provide sufficient movement sensor data for a software or firmware program to distinguish between the movement behavior of walk or trot. Thus, a relatively small wearable monitoring device can be used to track relevant movement behavior in the binary of walk or trot for a dog equipped with the wearable monitoring device.

Once the movement sensor signal in the form of movement sensor data is collected, the movement sensor data can be processed onboard the wearable monitoring device 130 or elsewhere, e.g., the client device(s) and/or the analysis server systems. Processing of the movement sensor data can provide information suitable for characterizing movement behavior as either walk or trot. As mentioned, in the present disclosure, other types of movement behaviors can be disregarded, such as running, jumping, lying down, sleeping, etc., as the movement behavior of walk and trot have been found to be sufficient for trained artificial intelligence to make a prediction of healthy mobility or compromised mobility. For example, a machine learning classifier(s) can be used to determine a predicted mobility of the dog movement based on the movement sensor data collected.

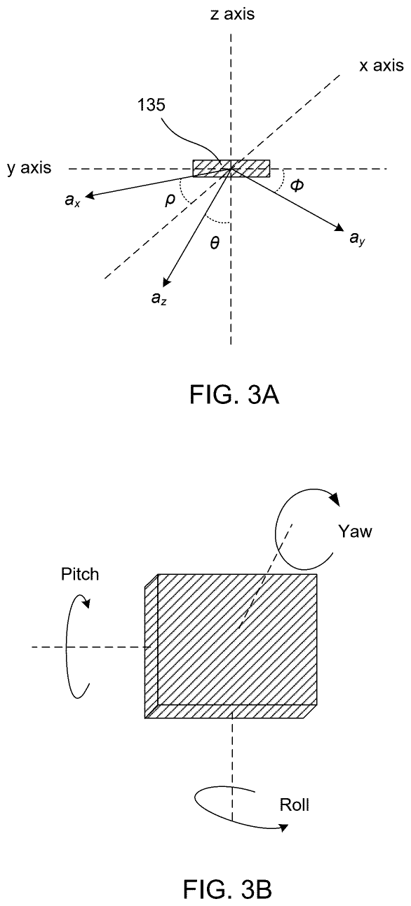

Referring now to FIG. 3A, an example schematic illustration of the operation of an accelerometer 135 is shown. In some examples, as the accelerometer is configured for inclusion in the wearable monitoring device, the accelerometer may be a triaxial MEMS accelerometer that is small enough to fit within the construction of the upper and lower housings 138A and 138B, though positioning outside of the housing may also occur, such as along the dog collar. As an example, a micromachined micro-electromechanical systems (MEMS) accelerometer can be used, similar to those used in handheld smartphones, cameras, video-game controllers, etc., which can be equipped for detecting movement and orientation. In accordance with the present disclosure, the triaxial accelerometer can be equipped to detect movement and orientation of the wearable monitoring device. As this accelerometer is illustrated on a two-dimensional plane, it is notable that the x and z axes are shown along the same plane as the illustration, while the x axis is shown as a diagonal line, but this should be interpreted as being horizontally coplanar with the y axis. As per this illustration, when the wearable monitoring device moves solely in the x direction, only the x component of the movement may be recorded as movement sensor data (from the movement sensor signal collected by the sensors). When the wearable monitoring device moves solely in the y direction, only the y component of the movement may be recorded as movement sensor data. However, if moving in a direction having both an x component and a y component, both the x and the y components of the movement may be recorded. The same would be case for movement in the z direction (not shown). Z direction movement may include solely a z component vector, or the z direction movement may include the z component vector along with any x and/or y component vector(s) of movement.

FIG. 3B illustrates schematically a triaxial gyroscope device that may be equipped as part of the wearable monitoring device. Gyroscopes are typically used for measuring or maintaining orientation and angular velocity. Large spinning wheels or discs such as are used in mechanical gyroscopes used in many airplanes to maintain horizontal flight are likely not suitable for use with the present disclosure due to their size. On the other hand, there are gyroscopes that are much smaller and suitable for use with the present wearable monitoring devices. Such gyroscopes may include microchip MEMS gyroscopes that are often found in smaller electronics devices, which are sometimes referred to as gyrometers. These can be based on utilized components such as solid-state ring lasers, fiber optic, or the like. Higher sensitivities may be achievable using a quantum gyroscope, for example.

Referring now to FIG. 4, an example flow chart is shown that illustrates the collection of three independent axial signals (from the x, y, and z axes) for each of the two triaxial sensors, e.g., the triaxial accelerometer and the triaxial gyroscope. Thus, a total of six sensed movement vectors (x_{acc}, y_{acc}, z_{acc}, x_{gyr}, y_{gyr}, and z_{gyr}) can be collected (three from each sensor). In addition to the movement sensor data independently collected from each of these movement vectors (from axial signal), a magnitude of movement (or vector sum) can be calculated to establish a magnitude signal as data, as illustrated by way of example in FIG. 4. The magnitude signals (one from the accelerometer and one from the gyroscope) can thus be calculated based on the square root of the three axial signals (x²+y²+z²) collected for each of the two sensors. Thus, both independent axial signals can be obtained and magnitude signals can be calculated therefrom for each sensor, thus providing for the collection of independent axial data for each of the axes of the accelerometer and each of the axes of the gyroscope and for collecting/calculating magnitude signals or data therefrom.

Many uses of accelerometers and gyroscopes focus on the magnitude signal calculated from multiple axes of these types of sensors. However, it has been recognized that when trying to distinguish between healthy and compromised mobility in dogs, better predictions with respect to compromised mobility can be ascertained by factoring in the individual axial signals or data of each triaxial signal collected, as this additional information provides artificial intelligence a better “view” of the asymmetric movements of the dog, which are more associated with compromised mobility than that which can be ascertained by using only the calculated magnitude signals. Thus, in some examples, the independent axial signals from each of the accelerometer and the gyroscope can be used for the mobility prediction, but in some examples, the axial signals can be combined with the calculated magnitude signal to provide a more complete mobility signal for processing by the artificial intelligence in making predictions. As noted, the various signals obtained can be collected as data for storage and processing onboard the wearable mobility device or at least partially on the wearable mobility device.

FIG. 5 illustrates an example of the collection of movement sensor data that can occur from the three axes of each of the accelerometer and the gyroscope. In this particular example, a rolling time window is shown that includes three (3) time series sub-windows (shown in seconds). There could be fewer or greater than three time series sub-windows, but this example illustrates three time series sub-windows per one full rolling time window. Thus, if the rolling time window were to be set at 1.5 seconds in length, then t=0.5 second. If the rolling time window were to be set at 3 seconds in length, then t=1 second. If the rolling time window were set at 6 seconds, then t=2 seconds. In further detail, each time series sub-window is further divided by 15 timesteps, but there could be a fewer or greater number of timesteps. Thus, in the example shown, if t=0.5 second, obtaining 15 timesteps per each time series sub-window would occur at a sampling rate of 30 Hz in the example shown. If t=1 second, obtaining 15 timesteps per each time series sub-window would occur at a sampling rate of 15 Hz in the example shown. If t=2 second, obtaining 15 timesteps per each time series sub-window would occur at a sampling rate of 7.5 Hz in the example shown. Thus, the sampling rate can vary based on the length of the time series sub-windows. Alternatively (or additionally), there may be fewer or greater than 15 time steps per each time series sub-window. For example, a sampling rate of 15 Hz based on 2 second time series sub-windows (t=2) would result in 30 timesteps per time series sub-window, and so forth. The 15 timesteps shown in FIG. 5 is thus shown by way of example only. In the example shown having 15 timesteps per time series sub-window indicates 15 sensor collection events per time series sub-window, e.g., 30 Hz where t=0.5, 15 Hz where t=1, 7.5 Hz where t=2, etc. this can be likened to a framerate for videography. With this framework in mind, it is noted that the rolling time windows can typically range in length from about 1 second to about 30 seconds in length, and each time series sub-window therein can range in length from about 0.1 second to about 15 seconds, provided the number of time series sub-windows is greater in number than the number of time windows. Notably time values outside of these ranges can also be used. This arrangement of movement data collection, for example, can allow for the building or utilizing features via a rolling time window with multiple time series sub-windows included within each rolling time window. Rolling time windows may be used to collect the movement data occurring at “n,” as shown in FIG. 5, for example.

In further detail, multiple time windows, e.g., from 2 to about 10, from 2 to about 6, from 2 to about 4, etc., can be assembled together consecutively in blocks of time windows which carry the raw data that can be used to establish the movement behavior of walk or the movement behavior of trot occurring throughout a block of time windows, e.g., multiple consecutive time windows where movement sensor data indicates the dog is walking (walk) or multiple consecutive time windows where movement sensor data indicates the dog is trotting (trot). The blocks of time windows in this example are not in the form rolling data, but rather fixed movement sensor data collected during the multiple consecutive time windows. Thus, the prediction of whether the dog is exhibiting healthy or compromised movement can be based on the movement behavior of walk or the movement behavior of trot occurring during the multiple consecutive time windows. The prediction that is made at each of the time windows in typically assembled in these blocks of time windows so that there is enough data collected, e.g., taking information from the time window before and the time window after, for making a better prediction with respect the time window of interest. In further detail, the blocks of time windows (which include multiple consecutive time windows) can be assembled onboard the chip and then periodically, e.g., every 1 to 60 minutes, every 1 to 30 minutes, every 2 to 15 minutes, or every 3 to 10 minutes, sent to the cloud for further processing, such as to evaluate the walk and trot blocks to predict whether the dog that generated the data wearing the wearable monitoring device is exhibiting healthy or compromised mobility. Alternatively, the walk and trot blocks could be processed onboard the chip if available data space is present onboard the chip for carrying out this type of processing.

To provide a specific example by way of illustration, the time series sub-windows of 1 second can provide the framework where features are built to summarize the time series sub-window data for 1 second (at “n”) within multi-second rolling time window, e.g., 3 seconds. This multi-second rolling time window can may then be used to establish a block of (static, or non-rolling) time windows, e.g., 6 second block, 9 second block, 12 second block, etc., to build features and make predictions related to healthy or compromised mobility of dog movement. Many time domain features and frequency domain features can be built from the independent axial signals collected (three from the accelerometer and three from the gyroscope) and the magnitude signals that are calculated (one from the accelerometer and one from the gyroscope). By way of example, a total of 912 time domain features and frequency domain features have been identified and built on the axial signals and the magnitude signals. However, the use of such a large number of features may not be efficient in predicting the mobility of dog movement, e.g., healthy or compromised. To narrow down the selection of features, software such as Shapely (BSD-licensed Python package for manipulation and analysis of data) can be used to narrow down the number of features and which features should be selected so as to generate an acceptable accuracy percentage with respect to its mobility predictions. In this example, it has been found that fewer time and frequency domain features, e.g., about 60, were sufficient to make reasonable predictions for mobility of dog movement based on the collected movement sensor data indicating the movement behavior of walk or trot.

As movement sensor data can include information in the time domain, in frequency domain, or both, in some embodiments, the movement sensor data can be transformed from time domain data to frequency domain data. For example, time domain data can be transformed into frequency domain data using a variety of techniques, such as a Fourier transform. Similarly, frequency domain data can be transformed into time domain data using a variety of techniques, such as an inverse Fourier transform. In some embodiments, time domain features and/or frequency domain features can be identified based on particular peaks, valleys, and/or flat spots within the time domain data and/or frequency domain data as described herein. In further detail, the time domain features and/or the frequency domain features for individual movement sensors, e.g., triaxial accelerometer and triaxial gyroscope, can be used by a machine learning classifier, and in some examples, features may be used simultaneously by the machine learning classifier. Classifying the events can include determining labels identifying the features and a confidence metric indicating the likelihood that the labels correspond to the ground truth of the events (e.g., the likelihood that the labels are correct). These labels can be determined based on the features, phase, and/or a variety of other data.

In further detail regarding the features that can be used in training and testing the artificial intelligence of the present disclosure, example features can include, but are not limited to, the standard deviation of one or more of the axial signals, a length of a flat spot, a crossover count of mean, a unique peak count, a distinct movement value count, a ratio of distinct movement values to event duration, a count of max movement changes in individual sensors, a medium movement bin percentage, a high movement bin percentage, a high movement bin volatility, a high movement bin variance, an automatic correlation function lag or latency, curvature, linearity, count of peaks, energy, minimum power, a power standard deviation, maximum power, largest variance shift, a maximum Kulback-Leibler divergence, a Kulback-Leibler divergence time, spectral density entropy, automatic correlation function differentials, and/or a variation of an autoregressive model. Movement behaviors can thus be classified based on a correlation with the classified features. For example, the selected features can be used as inputs to machine learning classifiers to classify the movement behaviors. The classified movement behavior of walk or trot can include a label indicating the type of movement behavior and/or a confidence metric indicating the likelihood that the label is correct. The machine learning classifiers can be trained on a variety of training data indicating movement behaviors and ground truth labels with the features as inputs.

With respect to the use of the time domain features, frequency domain features, or both that were identified for potential use, these features can be considered and narrowed to the most relevant features most closely associated with characterizing the movement behavior as a binary of walk or trot. In one example, the narrowing can be carried out manually. In other examples, programs such as Shapely can be used to assist with the narrowing down of the total number of features used, if desired. Training of the artificial intelligence and making mobility predictions can be carried out using a machine learning classifier, which can be described in general terms as an Artificial Intelligence (AI) model. Machine learning classifiers provide for a supervised machine learning method where a given model is trained and attempts to predict the correct label of a given input data. In the context of the present disclosure, the prediction may be a mobility prediction of dog movement selected from healthy mobility or compromised mobility. After training various models using a cohort of training dogs, for example, these various models can be evaluated by testing the predictions made and comparing those predictions to truth data, e.g., observation, medical diagnosis, etc., to evaluate how well the model performed with respect to its prediction(s). Example machine learning classifiers that can be used, some of which were evaluated in the context of the present disclosure, include decision trees (e.g. random forests), k-nearest neighbors, support vector machines (SVM), artificial neural networks (ANN), recurrent neural networks (RNN), convolutional neural networks (CNN), and/or probabilistic neural networks (PNN). RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In some examples, a combination of machine learning classifiers can be utilized. More specific machine learning classifiers when available, and general machine learning classifiers at other times, can further increase the accuracy of predictions. In accordance with the present disclosure, more specific machine learning classifiers (or models) that were tested included XGBoost, LightGBM, decision tree, artificial neural network (ANN), and long short-term memory (LSTM).

As the present disclosure relates to a binary classification task of two mutually exclusive categories, e.g., predicting healthy or compromised mobility, the machine learning classifier can be used to classify input data, which in this instance relates to the six independent axial signals and the two magnitude signals, initially for training the artificial intelligence to detect one of two movement behaviors, e.g., walk and trot, which can then be used to predict the mobility of dog movement, e.g., healthy or compromised. Regarding detection and characterization of the movement behavior of walk vs. trot, heuristics can be used onboard the wearable monitoring device, such as on the circuit board or chip having the processor and the memory. In other examples, the output of a movement behavior classifier could be used, particularly if it provides enough information to determine the movement behavior of walk or trot. Thus, the movement behavior of walk or trot as identified within various blocks of time windows may be identified by heuristics and/or by a machine learning classifier.

A heuristic(s) or heuristic technique relates to problem solving that may be imprecise and not particularly optimized, similar to the use of mental shortcuts, rules of thumb, etc. As there is ample movement sensor signal obtained and collected as movement sensor data, and as chip can include memory and processing suitable for capturing accessing data related to the movement behavior of walk or trot, heuristics provides a way of collecting and characterizing such data by approximation or attribute substitution that is considered to be “good enough” for the task at hand. The use of heuristic methods can provide lower data storage requirements (if that is a concern) and can provide a generally satisfactory solution while reducing the cognitive load of decision making. In accordance with the present disclosure, the chip may be programmed or taught to be smart enough to identify movement sensor data indicating the movement behavior of walk or trot. For example, heuristics can be used so that the chip is smart enough to know what sensor movement data to collect, e.g., walking and trotting, and what sensor movement data to exclude, e.g., resting, running, sleeping, etc. In some examples, the algorithms of logistic regression and/or support vector machines could be used, as they are natively designed for binary classifications. However, other algorithms such as k-nearest neighbors and/or decision trees can also be used for binary classification.

By way of example, a machine learning classifier that can be used either onboard the wearable monitoring device or after uploading to an analysis server system (or the cloud) may include an ANN classifier, which is sometimes referred to as an artificial neural network or neural net (abbreviated ANN). For context, an ANN includes connected units or nodes called artificial neurons connected by edges (which are similar to the biological structure of the synapses in the brain). Artificial neurons receive signals from connected neurons and then can process them and send signals to other connected neurons. Typically, the signal is based on real data or a real number(s), and the output coming therefrom from the various neurons can be computed by an activation function, which can be described as a non-linear function of the sum of its inputs. The strength of each signal is weighted, which can be adjusted during the learning (training) process. As ANNs can be used for predictive modeling, adaptive control, and solving problems in artificial intelligence, they provide a good candidate for machine learning from experience (training cohort) and can derive conclusions from complex information that may even seem unrelated in some instances. Training of the ANN can be carried out by any of a number of training methodologies, such as empirical risk minimization, gradient-based methods such as backpropagation, or others. Regardless of the methodology used, ANNs can learn from labeled training data, for example, by iteratively updating their parameters to minimize a defined loss function. In some examples, ANNs can be used to generalize from even unseen data.

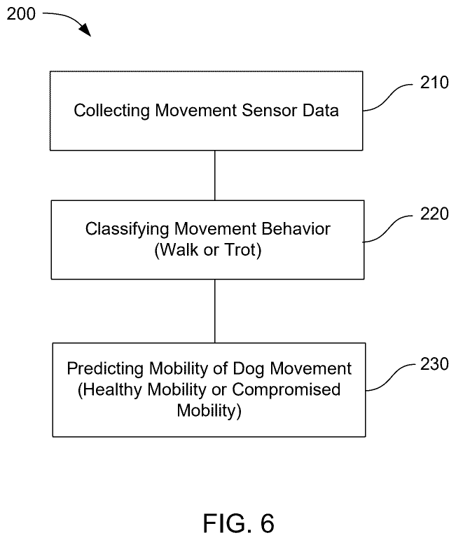

With this background, FIG. 6 illustrates an example flow diagram 200 that can be used to predict the mobility of dog movement based on movement sensor data collected via a wearable monitoring device. In this example, predicting the mobility of dog movement can include collecting 210 movement sensor data, which can be done at the timestep level. For example, the timestep data collection increment may be set at any frequency or timestep value that is appropriate for the specific situation, as described previously.

Once the movement sensor data is collected, the flow diagram 200 method shown can include accumulating data in time windows, where features related to the movement sensor data are used (which may have been generated during training). Features can be developed for use with the movement sensor data, which can be analyzed in terms of time domain features or frequency domain features. Time domain features can include, but are not limited to, mean, median, standard deviation, range, autocorrelation, or the like. An example of a time domain feature may be identified as a full period of movement indicated by one or more of the various sensor axes (based on axial signals and/or calculated magnitude signals, for example). The time domain features can be created as inputs for the machine learning classifier that is being used. More specific examples of time domain features that may be used to identify movement behavior data for walk or trot may be jerk, velocity, pitch, roll, peak distance threshold for peak detection, crest prominence threshold for peak detection, trough prominence threshold for peak detection, number of lags for autocorrelation feature calculation, etc. The term “jerk” refers to the rate of change of acceleration over time, e.g., change of rage of the movement sensor(s) in this instance. The vector quantity of jerk includes both magnitude and direction. For example, jerk (j) can be expressed as the first time derivative of acceleration, second time derivative of velocity, and third time derivative of position.

Frequency domain features can include, but are not limited to, median, energy, power spectral density, or the like. The frequency domain features can also be created as inputs for the machine learning classifier selected for use. In some examples, there may be only time domain features. In other examples, there may be feature domain features used with the time domain features, such as frequency domain median in frequency bins, frequency domain energy in frequency bins, frequency domain Welch power spectral density (PSD). Welch PSD refers to an approach for power spectral density estimation, where the power of signal may be estimated at different frequencies using periodogram spectrum estimates, resulting from converting a signal from the time domain to the frequency domain. In some examples, the movement sensor data collected at the timestep duration level and then aggregated at the time window duration level can be selected for use that correlates well with the binary objective of characterizing the movement behavior of walk or trot, for example. For example, potential features found in the time and/or frequency domain that was collected by the movement sensors can be looked at independently or aggregated to find those most closely associated with the movement behaviors of interest. Aggregation can be any mathematical operation including, but not limited to, sums and averages of the potential features.

After accumulating the data in time windows, identified features or aggregates of features of the individual time windows can be used for classifying 220 movement behavior, with a focus on the movement behavior of walk or trot (discarding time windows with other types of movement, e.g., running, resting, sleeping, playing, etc.). Alternatively, the use of models, such as FilterNet modeling, may also produce acceptable results by using the raw axial data, the magnitude data, and/or jerk signals as the input, rather than relying on feature generation in predicting 230 mobility of the dog movement, e.g., a healthy mobility or compromised mobility. Instead, features can be extracted automatically from the raw sensor data. FilterNet modeling (or ensemble neural network modeling) can be used for time series analysis, which may utilize one-dimensional convolutional neural network and a MixedInputModel (Fast.AI). These models may provide a model class along with its corresponding dataset class, for example. When using FilterNet modeling, for example, systems and methods described herein may still include

In further detail, heuristics, decision tree, etc., or other similar classification and machine learning modeling approaches can be used to determine types of movement that occurred within the various time windows based on the movement sensor data collected by the movement sensors, e.g., the accelerometer and the gyroscope. With this approach, time windows with sensor movement data indicating the movement behavior of walk or trot, can be used for further processing in making mobility predictions of dog movement.

The artificial intelligence can be used in aggregating multiple consecutive time windows where a common movement behavior is identified, and in particular multiple consecutive time windows indicating the movement behavior of walk or multiple consecutive time windows indicating the movement behavior of trot. The number of consecutive time windows with a common movement behavior may range from 2 to about 10, from 2 to about 8, from 2 to about 5, from 2 to about 4, or about 3, for example. To illustrate, three consecutive time windows showing the movement behavior of walk or trot may result in a block of time windows that is a 3x multiple of the length of the time window. Thus, a 3 second time window with three consecutive time window blocks would result in a 9 second block of time windows. The length of time that has been found to be particularly useful in predicting mobility of dog movement as healthy or compromised mobility is about 9 seconds or more, e.g., from about 9 seconds to about 10 minutes, from about 9 seconds to about 5 minutes, from about 9 seconds to about 120 seconds, from about 9 seconds to about 60 seconds, from about 9 seconds to about 45 seconds, from about 9 seconds to about 30 seconds, or from about 9 seconds to about 15 seconds. Shorter aggregated blocks of time windows (less than about 9 seconds) when trying to characterize a movement behavior (walk or trot) may not be as effective at predicting mobility of dog movement as healthy or compromised mobility, as it may be too short to capture more than just a few full movement cycles. For example, about 9 seconds has been found to be a reasonable (or in some instances minimal) amount of time that may be used predict walk or trot at the second level, because classifying mobility of dog movement, on average, can be a long enough period to make this differentiation. Longer durations can also be used, though those may require more data storage and/or processing. With that said, to the extent shorter aggregated blocks of time windows can provide enough information to distinguish between walk or trot (and ultimately healthy or compromised mobility), short time frames may be useable.

Once the multiple blocks of time are aggregated with relevant common movement behaviors, e.g., walk or trot, the systems or methods described herein can include predicting 230 mobility of the dog movement as healthy mobility or compromised mobility. Thus, a mobility model can be trained with a cohort of dogs and can be applied to the blocks of consecutive time windows exhibiting walk or trot to predict if the dog in question is exhibiting healthy or compromised mobility. The prediction can be based on an AI or machine learning algorithm that has been found to provide acceptable predictive results, e.g., at least about 60% correct, at least about 70% correct, at least about 75% correct, or at least about 80% correct. Machine learning models can utilized features that are generated in making these predictions. Alternatively, the use of other machine-learning models, such as FilterNet modeling, can also produce acceptable results by using the raw axial data, the magnitude data, and/or jerk signals as the input, rather than relying on feature generation.

Though FIG. 6 illustrates a flowchart related to the systems and methods of the present disclosure for predicting mobility of dog movement, it will be appreciated that many other systems may be used or methods carried out in performing the actions associated with the various steps implemented in this FIG. For example, the order of some of the blocks may be changed, certain blocks may be combined with other blocks, one or more blocks may be repeated, and/or some of the blocks described are optional. The method may be performed by processing logic that may include hardware (circuitry, dedicated logic, etc.), software, or a combination of both. The method or process may be implemented as instructions on a machine, where the instructions are included on at least one computer readable medium or one non-transitory machine-readable storage medium.

Tables 1-2 below provide data related to the training and testing of artificial intelligence. In this example, there were 43 total dogs used, with 34 being used as “training dogs” and 9 being used as “testing dogs.” This, and additional data regarding the cohorts of dogs is shown by way of example in Table 1:

TABLE 1
Dogs Selection and Training/Testing of Artificial Intelligence
Number of Dogs for AI Training and Testing

| | |
|---|---|
| Training Dogs | 34 |
| Testing Dogs | 9 |
| Total Number of Dogs | 43 |

Number of Sessions Carried Out on Healthy and Compromised Dogs

| | |
|---|---|
| Healthy Mobility | 136 |
| Compromised Mobility | 122 |
| Total Number of Dogs | 258 |

| Dog Grouping | Dog Health | Session Count |
|---|---|---|
| Training Dogs | Compromised Mobility | 98 |
| | Healthy Mobility | 110 |
| Testing Dogs | Compromised Mobility | 24 |
| | Healthy Mobility | 26 |

With the 43 total number of dogs, multiple sessions were carried out, with individual dogs selected for training and testing undergoing anywhere from 1 session to about 10 sessions. Various testing parameters were tested including: sensor type, e.g., accelerometer and/or gyroscope; sensor vectors, e.g., magnitude signals, axial signals, or both; machine learning classifiers (or AI models), e.g., XGBoost, LightGBM, decision tree (DT), artificial neural network (ANN), and long short-term memory (LSTM); event lengths for time windows and blocks of time windows, e.g., blocks of time windows at totaling the full length of the data collection session, 30 seconds, 45 seconds, and 9 seconds; number of features, e.g., ranging from 6 to 912; hyperparameter tuning (Y/N); number of training windows, e.g., ranging from 120 to 1138; and testing windows, e.g., ranging from 112 to 625. By mixing and matching these parameters, both the training performance and testing performance were characterized using its respective F score (or F1 score), precision performance, and recall performance. Some of the models were then evaluated for their respective file size, e.g., KB or MB sized files, with a goal to balance the model file size for predictive accuracy while keeping the file size relatively low, with file sizes that were measured ranging from 5 KB to 331 KB.

After testing several of the various combinations of parameters set forth above, it was found that a good balance between file size and the ability to effectively run the heuristics or other machine-learning classification on the chip of the wearable monitoring device, thus achieving reasonable F1 scores, precision, and/or recall, as shown in Table 2 below:

TABLE 2
Predicting Mobility of Dog Movement Using
AI Training Cohort and Testing Cohort

| Parameters | | | | | | | |
|---|---|---|---|---|---|---|---|
| 1) Model ID | | | | | | | |
| 2) Event Duration* | | Train Performance | | | Test Performance | | |
| 3) # of Features | | F1 | | | F1 | | |
| 4) Local Model Size | | Score | Precision | Recall | Score | Precision | Recall |
| 1) LightGBM | | 87.96% | 87.99% | 87.96% | 73.63% | 73.71% | 73.59% |
| 2) Variable | | | | | | | |
| 3) 30 | | | | | | | |
| 4) 190 | KB | | | | | | |
| 1) ANN | | 78.10% | 78.12% | 78.11% | 63.51% | 64.76% | 64.56% |
| 2) 9 | seconds | | | | | | |
| 3) 52 | | | | | | | |
| 4) 7.57 | KB | | | | | | |
| 1) LightGBM | | 87.96% | 87.99% | 87.96% | 64.45% | 64.43% | 64.48% |
| 2) 15 | seconds | | | | | | |
| 3) 40 | | | | | | | |
| 4) 807 | KB | | | | | | |
| 1) LightGBM | | 93.80% | 93.82% | 93.80% | 70.89% | 70.91% | 70.88% |
| 2) 30 | seconds | | | | | | |
| 3) 20 | | | | | | | |
| 4) 113 | KB | | | | | | |
| 1) LightGBM | | 99.52% | 99.52% | 99.52% | 73.79% | 73.77% | 73.81% |
| 2) 45 | seconds | | | | | | |
| 3) 20 | | | | | | | |
| 4) 239 | KB | | | | | | |
| 1) ANN | | 78.93% | 78.93% | 78.97% | 75.96% | 76.33% | 75.89% |
| 2) 45 | seconds | | | | | | |
| 3) 52 | | | | | | | |
| 4) 5 | KB | | | | | | |

*Event Length refers to the block of time windows sequentially assembled together to classify the movement behavior as walk or trot.

As can be seen from this data, acceptable results can be achieved with various machine-learning models, event lengths (blocks of time windows), and the number of features used in training and testing (or making predictions). More specifically, in the example shown in Table 2, utilizing a mobility model for dog movement (compromised mobility or healthy mobility); onboard data collection related to the movement behavior of walk or trot (excluding other types of mobility, e.g., rest, running, excited play, etc.); proper selection of a machine-learning model, e.g., LightGBM or artificial neural network (ANN); adequate event durations (or blocks of time windows), e.g., 9 seconds or greater; appropriate selection of rolling time window durations, e.g., typically at least about 1 second to about 30 seconds, or about 2 seconds to about 30 seconds (which will be shorter in length than the full event duration); number and choice of features selected, e.g., from 20 to 52 features; varied number training windows, and/or varied number of test windows, etc., acceptable results could be achieved. Other models and parameters also can produce acceptable results, but this data provides a few examples of parameters, testing performance, and training performance data illustrating the predictive value of the systems and methods described herein. In further detail, when looking at the F1 scores, precision, and recall, longer event lengths tended to increase the results. However, shorter lengths are still shown as providing positive results as it relates to making acceptable predictions regarding mobility of the dog movement. If the goal is to keep the local size of the model low, then in this comparative example, the ANN model seemed to provide a better model for meeting that goal, providing acceptable results at 9 second event lengths and excellent results at 45 second event lengths. Thus, a balance can be stuck based upon desired goals in selecting from various models, event lengths, features, and/or local model sizes.

With this in mind, it is noted that a performance-based analysis can be used to determine the least amount of data that is needed to achieve acceptable prediction results. Typically, better modeling and predictions can be achieved in part based on the machine-learning model selected, the predictions tend also improve (though not always) by providing larger blocks of time windows (event length), larger local model sizes, and appropriate selection and number of features. With that stated, sampling of the results achieved under various parameters were deemed to provide acceptable results even when more minimalistic approaches were implemented, such as a 9 second event length (blocks of time windows) and very small local model size, e.g., 7.57 KB. As also noted, similar data can be achieved using other types of models that do not utilize feature generation, such as FilterNet modeling. FilterNet modeling, for example, can produce acceptable results by using raw axial data, magnitude data, and/or jerk signals as the input.

It will be appreciated that all of the disclosed systems and methods described herein can be implemented using one or more computer programs, components, and/or program modules. These components may be provided as a series of computer instructions on any conventional computer readable medium or machine-readable medium, including volatile or non-volatile memory, such as RAM, ROM, flash memory, magnetic or optical disks, optical memory, or other storage media. The instructions may be provided as software or firmware and/or may be implemented in whole or in part in hardware components such as ASICs, FPGAs, DSPs, or any other similar devices. The instructions may be configured to be executed by one or more processors which, when executing the series of computer instructions, performs or facilitates the performance of all or part of the disclosed methods and procedures. As will be appreciated by one of skill in the art, the functionality of the program modules may be combined or distributed as desired in various aspects of the disclosure.

In accordance with the disclosure herein, the following examples are illustrative of several embodiments of the present technology.

1. A method of predicting mobility of dog movement, under the control of at least one processor, comprising:

collecting movement sensor data from a wearable monitoring device positioned on a dog, wherein the wearable monitoring device includes:
an accelerometer capable of collecting three accelerometer axial signals,
a gyroscope capable of collecting three gyroscope axial signals,
a processor,
a memory storing instructions that, when executed by the processor, accumulates the movement sensor data in time windows;
classifying movement behavior as a binary of walk or trot within at least a plurality of the time windows based on the movement sensor data collected from multiple axes of the accelerometer and multiple axes of the gyroscope; and
predicting mobility of dog movement based on the movement behaviors as applied to a trained artificial intelligence mobility model, wherein predicting the mobility of the dog movement includes predicting a binary of healthy mobility or compromised mobility.

2. The method of example 1, wherein predicting the mobility of the dog movement includes aggregating:
blocks of consecutive time windows with the movement sensor data correlated to the movement behavior of walk, or
blocks consecutive time windows with the movement sensor data correlated to the movement behavior of trot,
wherein predicting mobility of the dog movement is based at least in part on the blocks of consecutive time windows that include the movement behavior of walk, or blocks of consecutive time windows that include the movement behavior of trot, or both.

3. The method of one of examples 1 to 2, wherein classifying the movement behaviors includes comparing the movement sensor data to established time domain features, frequency domain features, or both that are correlated to the movement behavior of walk or the movement behavior of trot.

4. The method of one of examples 1 to 3, wherein the accelerometer and the gyroscope each collect three axial signals to provide axial data related to asymmetric dog movement, and wherein magnitude and jerk data generated from axial data of the accelerometer and the gyroscope relates to overall dog movement.

5. The method of one of examples 1 to 4, wherein the instructions, when executed by the processor, also implements classifying the movement behaviors onboard the memory of wearable monitoring device.

6. The method of example 5, wherein the instructions, when executed by the processor, also implements predicting the mobility of the dog movement onboard the memory of the wearable monitoring device.

7. The method of example 5, further comprising periodically communicating the movement sensor data to an analysis server system or a cloud computing system via a wireless network, a client device via a wired or wireless non-network link or via a wireless network, or both.

8. The method of one of examples 1 to 7, wherein classifying the movement behaviors includes identifying multiple time series sub-windows within one or more rolling time windows, and wherein time domain features and frequency domain features are identified within the time series sub-windows.

9. The method of one of examples 1 to 8, wherein the sensor data is collected solely from the wearable monitoring device, and the wearable monitoring device consists of sensors selected from the accelerometer and the gyroscope.

10. The method of one of examples 1 to 9, further comprising generating and sending an electronic notification regarding the mobility of the dog movement.

11. A mobility prediction system of dog movement, comprising:
a wearable monitoring device positionable on a dog, wherein the wearable monitoring device includes an accelerometer, a gyroscope, a processor, a memory storing instructions that, when executed by the processor, accumulates movement sensor data using three accelerometer axes and three gyroscope axes;
a machine classifier to classify movement behaviors as walk or trot within at least a plurality of the time windows based on the movement sensor data; and
a trained artificial intelligence model to provide a mobility prediction for dog movement based on the movement behaviors, wherein the mobility prediction of dog movement is a binary of healthy mobility or compromised mobility.

12. The prediction system of example 11, wherein one or both of the machine classifiers or the trained artificial intelligence are stored on the memory and accessed using the processor onboard the wearable monitoring device.

13. The prediction system of one of examples 11 to 12, wherein one or both of the machine classifiers or the trained artificial intelligence are stored remotely on a remote memory of analysis server system, a cloud computing system, or a client device having a remote, and wherein the remote memory is accessed by a remote processor to classify the movement behavior or predict the mobility of the dog movement.

14. The prediction system of one of examples 11 to 13, wherein the wearable monitoring device further comprises a data communicator to communicate raw sensor data, accumulated sensor data, processed sensor data, classified movement behavior, aggregated consecutive time window block data, prediction data, or a combination thereof with an analysis server system, a cloud computing system, a client device, or a combination thereof.

15. The prediction system of one of examples 11 to 14, wherein the accelerometer and the gyroscope each collect three individual axial signals to provide axial data related to asymmetric movement, and wherein magnitude data is calculated from the axial data to characterize overall movement.

16. The prediction system of one of examples 11 to 15, wherein the memory also stores instruction that, when executed by the processor, utilizes multiple consecutive time windows to establish the movement behavior of walk, utilizes multiple consecutive time windows to establish the movement behavior of trot, or a combination thereof.

17. The prediction system of one of examples 11 to 16, wherein at least a plurality of the time windows include multiple time series sub-windows, wherein time domain features, the frequency domain features, or both are identified within the time series sub-windows.

18. The prediction system of one of examples 11 to 17, wherein the machine classifier classifies the movement behaviors by comparing the movement sensor data to established time domain features, frequency domain features, or both that are correlated to the movement behavior of walk or the movement behavior of trot.

19. The prediction system of one of examples 11 to 18, wherein the mobility prediction of dog movement is carried out by the artificial intelligence occurs by aggregating blocks of consecutive time windows with the movement sensor data correlated to the movement behavior of walk, or aggregating blocks consecutive time windows with the movement sensor data correlated to the movement behavior of trot.

20. A non-transitory machine readable storage medium having instructions embodied thereon, the instructions when executed cause a processor to perform a method of predicting mobility of dog movement, comprising:
accumulating movement sensor data in time windows using three axes of an accelerometer and three axes of a gyroscope;
classifying movement behavior as a binary of walk or trot within at least a plurality of the time windows based on the movement sensor data; and
one or both of:
   predicting the mobility of the dog movement based on the movement behaviors as applied to a trained artificial intelligence mobility model, wherein the mobility of the dog movement predicted is a mobility prediction of the dog movement selected from healthy mobility or compromised mobility, or
   transmitting data collected from classifying the movement behaviors over a network or non-network link to an analysis server, a cloud computing system, a client device, or a combination thereof where predicting the mobility of the dog movement occurs.

### Definitions

The term, “about” is typically used herein in the context of providing numerical ranges or numerical values. For example, a range of about 10 to about 100 may extend slightly beyond the outer limits of the range, e.g., from −10% to +10% of the number value, from −5% to +5% of the number value, from −1% to +1% of the number value, or from −0.1% to +0.1% of the number value. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth. Furthermore, each range of number values that includes the term “about” also directly supports the range bound by the exact number values, which can be read as though the term “about” is not present on one or both ends of the range.

As used in this disclosure and the appended claims, the singular forms “a,” “an” and “the” include plural referents unless the context clearly dictates otherwise. Thus, for example, reference to “a component” or “the component” includes two or more components.

The terms “comprise,” “comprises” and “comprising” are to be interpreted inclusively rather than exclusively. Likewise, the terms “include,” “includes, and “including” are also construed to be inclusive, unless such a construction is clearly prohibited from the context. Furthermore, the use of these or other inclusive terms are to be interpreted as also supporting the use of the transition phrases “consisting essentially of” and “consisting of.”

The term “and/or” used in the context of “X and/or Y” should be interpreted as “X,” or “Y,” or “X and Y.” Similarly, “at least one of X or Y” should be interpreted as “X,” or “Y,” or “X and Y.”

The terms “for example,” “an example, “such as,” or the like, particularly when followed by a listing of terms, are merely exemplary and illustrative and should not be deemed to be exclusive or comprehensive.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced otherwise than specifically described without departing from the scope and spirit of the present disclosure. Thus, aspects of the present disclosure should be considered in all respects as illustrative and not restrictive. It will be evident to the annotator skilled in the art to freely combine several or all of the aspects discussed here as deemed suitable for a specific application of the disclosure.

What is claimed is:

1. A method of predicting mobility of dog movement, under the control of at least one processor, comprising:
collecting movement sensor data from a wearable monitoring device positioned on a dog, wherein the wearable monitoring device includes:
an accelerometer capable of collecting three accelerometer axial signals,
a gyroscope capable of collecting three gyroscope axial signals,
a processor,
a memory storing instructions that, when executed by the processor, accumulates the movement sensor data in time windows;
classifying movement behavior as a binary of walk or trot within at least a plurality of the time windows based on the movement sensor data collected from multiple axes of the accelerometer and multiple axes of the gyroscope; and
predicting mobility of dog movement based on the movement behaviors as applied to a trained artificial intelligence mobility model, wherein predicting the mobility of the dog movement includes predicting a binary of healthy mobility or compromised mobility.

2. The method of claim 1, wherein predicting the mobility of the dog movement includes aggregating:
blocks of consecutive time windows with the movement sensor data correlated to the movement behavior of walk, or
blocks consecutive time windows with the movement sensor data correlated to the movement behavior of trot,
wherein predicting mobility of the dog movement is based at least in part on the blocks of consecutive time windows that include the movement behavior of walk, or blocks of consecutive time windows that include the movement behavior of trot, or both.

3. The method of claim 1, wherein classifying the movement behaviors includes comparing the movement sensor data to established time domain features, frequency domain features, or both that are correlated to the movement behavior of walk or the movement behavior of trot.

4. The method of claim 1, wherein the accelerometer and the gyroscope each collect three axial signals to provide axial data related to asymmetric dog movement, and wherein magnitude and jerk data generated from axial data of the accelerometer and the gyroscope relates to overall dog movement.

5. The method of claim 1, wherein the instructions, when executed by the processor, also implements classifying the movement behaviors onboard the memory of wearable monitoring device.

6. The method of claim 5, wherein the instructions, when executed by the processor, also implements predicting the mobility of the dog movement onboard the memory of the wearable monitoring device.

7. The method of claim 5, further comprising periodically communicating the movement sensor data to an analysis server system or a cloud computing system via a wireless network, a client device via a wired or wireless non-network link or via a wireless network, or both.

8. The method of claim 1, wherein classifying the movement behaviors includes identifying multiple time series sub-windows within one or more rolling time windows, and wherein time domain features and frequency domain features are identified within the time series sub-windows.

9. The method of claim 1, wherein the sensor data is collected solely from the wearable monitoring device, and the wearable monitoring device consists of sensors selected from the accelerometer and the gyroscope.

10. The method of claim 1, further comprising generating and sending an electronic notification regarding the mobility of the dog movement.

11. A mobility prediction system of dog movement, comprising:
a wearable monitoring device positionable on a dog, wherein the wearable monitoring device includes an accelerometer, a gyroscope, a processor, a memory storing instructions that, when executed by the processor, accumulates movement sensor data using three accelerometer axes and three gyroscope axes;
a machine classifier to classify movement behaviors as a binary of walk or trot within at least a plurality of the time windows based on the movement sensor data; and
a trained artificial intelligence model to provide a mobility prediction of dog movement based on the movement behaviors, wherein the mobility prediction of the dog movement is either healthy mobility or compromised mobility.

12. The prediction system of claim 11, wherein one or both of the machine classifiers or the trained artificial intelligence are stored on the memory and accessed using the processor onboard the wearable monitoring device.

13. The prediction system of claim 11, wherein one or both of the machine classifiers or the trained artificial intelligence are stored remotely on a remote memory of analysis server system, a cloud computing system, or a client device having a remote, and wherein the remote memory is accessed by a remote processor to classify the movement behavior or predict the mobility of the dog movement.

14. The prediction system of claim 11, wherein the wearable monitoring device further comprises a data communicator to communicate raw sensor data, accumulated sensor data, processed sensor data, classified movement behavior, aggregated consecutive time window block data, prediction data, or a combination thereof with an analysis server system, a cloud computing system, a client device, or a combination thereof.

15. The prediction system of claim 11, wherein the accelerometer and the gyroscope each collect three individual axial signals to provide axial data related to asymmetric movement, and wherein magnitude data is calculated from the axial data to characterize overall movement.

16. The prediction system of claim 11, wherein the memory also stores instruction that, when executed by the processor, utilizes multiple consecutive time windows to establish the movement behavior of walk, utilizes multiple consecutive time windows to establish the movement behavior of trot, or a combination thereof.

17. The prediction system of claim 11, wherein at least a plurality of the time windows include multiple time series sub-windows, wherein time domain features, the frequency domain features, or both are identified within the time series sub-windows.

18. The prediction system of claim 11, wherein the machine classifier classifies the movement behaviors by comparing the movement sensor data to established time domain features, frequency domain features, or both that are correlated to the movement behavior of walk or the movement behavior of trot.

19. The prediction system of claim 11, wherein the mobility prediction of the dog movement is carried out by the artificial intelligence occurs by aggregating blocks of consecutive time windows with the movement sensor data correlated to the movement behavior of walk, or aggregating blocks consecutive time windows with the movement sensor data correlated to the movement behavior of trot.

20. A non-transitory machine readable storage medium having instructions embodied thereon, the instructions when executed cause a processor to perform a method of predicting mobility of dog movement, comprising:
accumulating movement sensor data in time windows using three axes of an accelerometer and three axes of a gyroscope;
classifying movement behavior as a binary of walk or trot within at least a plurality of the time windows based on the movement sensor data; and
one or both of:
predicting the mobility of the dog movement based on the movement behaviors as applied to a trained artificial intelligence mobility model, wherein the mobility predicted is a mobility prediction of the dog movement selected from healthy mobility or compromised mobility, or
transmitting data collected from classifying the movement behaviors over a network or non-network link to an analysis server, a cloud computing system, a client device, or a combination thereof where predicting the mobility of the dog movement occurs.
